(19) United States
(12) Patent Application Publication
(10) Pub. No.: US 2014/0118756 A1
(43) Pub. Date: May 1, 2014

(54) METHOD OF PRODUCING A CUSTOMIZED IMAGE ON A WEB OF MATERIAL

(71) Applicant: Chris Shepherd, Issaquah, WA (US)

(72) Inventor: Chris Shepherd, Issaquah, WA (US)

(21) Appl. No.: 14/061,136

(22) Filed: Oct. 23, 2013

Related U.S. Application Data
(60) Provisional application No. 61/717,898, filed on Oct. 24, 2012.

(51) Int. Cl. G06K 15/02

(52) U.S. Cl. CPC G06K 15/022
USPC 358/1.6

(57) ABSTRACT

A method allowing a customer to provide a customized design on a web of material involves the steps of giving the customer access to a database containing graphic image data, allowing the customer to select or manipulate the graphic image data contained in the database to obtain a desired graphic image; and allowing a third party to gain access to the desired graphic image to apply the desired graphic image on the web of material.

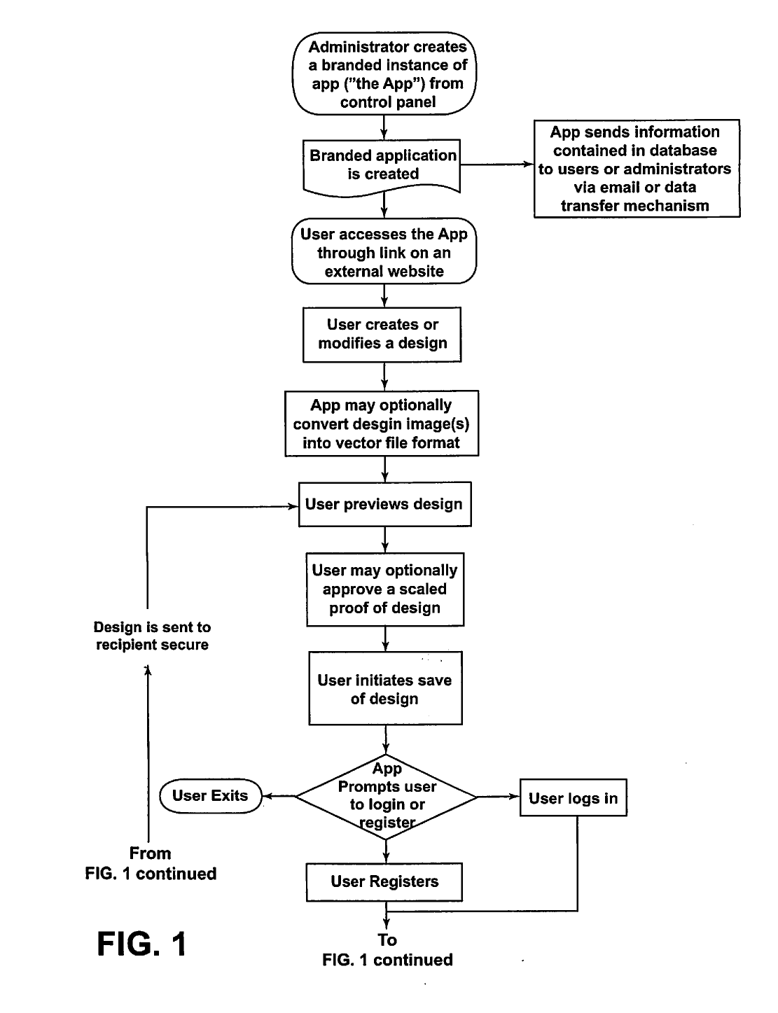

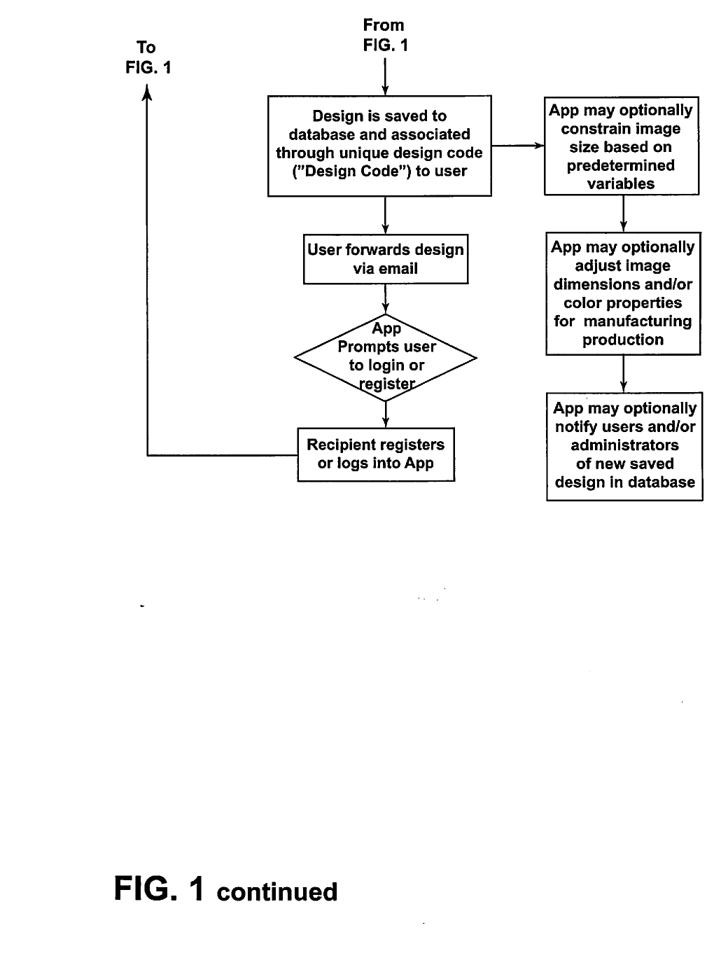

### CROSS-REFERENCE TO RELATED APPLICATION

This claims the benefit of U.S. Provisional Application No. 61/717,898, filed Oct. 24, 2012, the disclosure of which is hereby incorporated by reference in its entirety.

### FIELD OF THE INVENTION

The invention in general relates to electronic commerce and allows a customer to choose or design an image in a database and have that image applied to a web of material.

### BACKGROUND OF THE INVENTION

Commercial customers of web materials, such as fabrics, films, felts and other rolling materials and roll composites, typically have a problem when ordering a web material having a custom designed printing applied thereto, in that it requires a high minimum order, long lead times and investment in graphic design services. Moreover, the design on the web material is generally selected by the customer and then sent to a printing facility without any idea how the design will look on the web material finished product.

A traditional method for printing on a web of material is disclosed in U.S. Pat. No. 4,960,048 where offset printing presses are used to print on a web material as it is transferred from a first roll to a second roll of a similar size or from a web folded in a “stacked sheet” configuration, both before and after the printing step.

U.S. Pat. Nos. 7,004,220 to Rasmussen shows a machine for transfer pattern printing of a textile web wherein a textile web to be printed is wound off an unwind roll, brought into contact with a pattern-containing web, a die transfer and pattern-containing web to the textile web and the textile and the pattern-containing web are then wound up on rolling-up rolls.

U.S. Pat. No. 7,178,458 to Bates discloses a method of making transferred printing webbing in which a design is printed on a continuous roll paper with die transfer ink using a die transfer printer controlled by a personal computer during which a wide web is unwound from a roll, slit into a plurality of narrow webs which are then received in a receptacle.

U.S. Pat. No. 6,845,365 discloses a method and apparatus for creating and ordering customized branded merchandise over a computer network for goods such as soda bottles.

However, there is not currently any mechanism by which a customer can take advantage of today's electronic commerce and select or design a personalized graphic image from a database and have that personalized graphic image applied to a web material by digital printing. The present invention has been arrived at in order to satisfy this need.

### SUMMARY OF THE INVENTION

The present invention solves the above-discussed problems by providing a method for developing and ordering personalized web materials from a database.

### BRIEF DESCRIPTION OF THE DRAWING

The figure shows a flowchart illustrating a routine for creating a personalized web material according to the present invention.

### DETAILED DESCRIPTION OF THE PREFERRED EMBODIMENT

A possible customer can access a database containing graphic information to be provided on a web material through a web link such as a WWW site accessible through the internet through conventional means such as a browser application program such as Netscape's NAVIGATOR® or Microsoft's INTERNET EXPLORER®. The website contains a database containing graphic image data. The customer can enter the database and view various types of graphic image data contained therein that can be provided on a web material. In the database, the customer can select a particular design, create a design, modify a design, resize the design based on defined parameters, display the design, modify the design for use in a manufacturing process and store the design. If desired, the customer can additionally upload graphic image data into the database. Artwork template(s) are available for users to modify into customized finished artwork. These templates comprise fixed elements (graphical or text) and editable (text) elements. A conventional text editing tool allows for the designs contained in the database to be resized, rotated, cropped, moved and skewed. In addition, the database allows the customer to create sequential graphic images from the graphic image data contained therein. A computer system such as disclosed in U.S. Pat. No. 6,845,365 can be adapted to use in the present invention and the disclosure thereof is hereby incorporated by reference.

After selecting or creating the desired graphic image(s) that will be applied on a web material, the customer initiates the saving of the design in the database by logging in or registering with the database. The customer also has the option at this time to exit the database, if it is not desired to save the selected design. If the customer has registered in the database previously, he can merely log in using a previously existing identification code to save the design. If the customer has not registered previously, he is allowed to register with the database in order to save the design. The database allows the customer to view a two-dimensional or three-dimensional rendering of the desired design superimposed on a finished body. The selected design can be converted into vector form and image properties, dimensions and coloring for production may be adjusted.

After the design is saved in the database and associated with the customer through an identification code, the customer can either forward the selected design to a third party, such as a printing facility, by email or the third party can access directly with the details of the selected design from the database by logging in or registering with the data base.

Additionally, the present invention allows for a customer's approval of a two-dimensional rendering of the desired graphic image superimposed on a finished product being stored with a time-stamped record in a database, a customer's approval of a three-dimensional rendering of the design graphic image superimposed on a finished product stored with a time-stamped record in a database, a customer's approval of a desired graphic image stored with a time-stamped record in a database, the conversion of a rasterized graphic image into a vector image, the constraint of the graphic image dimensions based on estimated ink usage and the distance between multiple graphical images being constrained based on an estimated ink usage.

The printing facility can either print the design, or a version thereof, on the web material in a continuous or discontinuous fashion using a digital and/or flexographic printing process. If it is desired to print the design on the web material in a continuous fashion, the printing facility can be contained in a system such as disclosed in U.S. Patent Publication No. 2010-0021651A1. If it is desired to print the design on the web material in a discontinuous fashion, a system such as disclosed in U.S. Publication No. 2010-0021651A1 without an accumulator can be used.

While the present invention has been described with respect to a particular embodiment, it would be apparent to one of ordinary skill in the art that it is not so limited and is capable of being changed in various manners without departing from the scope of the present invention.

What is claimed is:

1. A method of producing a customized image on a web of material, comprising the steps of:
providing a database containing graphic image data;
allowing access to the database to a user for viewing the graphic image data;
allowing the user to enter new graphic image data into the database;
allowing the user to select or manipulate the graphic image data contained in the database to obtain a desired graphic image;
allowing the user to initiate the saving of the desired graphic image;
giving the user the option of exiting or continuing in the database;
registering the user if the user decides to remain in the database and has not registered previously;
logging the user into the database after the user is registered in the database;
saving the desired graphic image in the database in association with the user;
allowing the user to forward the desired graphic image to a third party for the web of material or requiring the third party to register or log-in with the database to access the desired graphic image; and
applying the desired graphic image, or a version thereof, onto the web of material by printing at a printing facility.

2. The method of claim 1, wherein the manipulation of the graphic image data involves at least one step selected from the group consisting of creating graphic image data from a text editing tool, creating a matrix barcode and creating sequential graphic images.

3. The method of claim 1, wherein the graphic image data viewed in the database by the user is two-dimensional graphic image data.

4. The method of claim 1, wherein the graphic image data viewed in the database by the user is three-dimensional graphic image data.

5. The method of claim 3, wherein the user is permitted to view a two-dimensional rendering of the desired graphic image superimposed on a finished product.

6. The method of claim 4, wherein the user is permitted to view a three-dimensional rendering of the desired graphic image superimposed on a finished product.

7. The method of claim 1, wherein the web of material is transferred from a first roll to a second roll which is smaller than the first roll at the printing facility.

8. The method of claim 1, wherein the transfer of the web of material from the first roll to the second roll is performed continuously.

9. The method of claim 1, wherein the transfer of the web of material from the first roll to the second roll is performed discontinuously.

10. The method of claim 1, wherein the printing is applied onto the web of material by at least one of digital printing and flexographic printing.

11. The method of claim 1, where a user's approval of a two-dimensional rendering of the desired graphic image superimposed on a finished product is stored with a time-stamped record in a database.

12. The method of claim 1, where a user's approval of a three-dimensional rendering of the desired graphic image superimposed on a finished product is stored with a time-stamped record in a database.

13. The method of claim 1, where a user's approval of the desired graphic image is stored with a time-stamped record in a database.

14. The method of claim 1, where a rasterized graphical image can be converted to a vector image.

15. The method of claim 1, where the graphical image dimensions are constrained based on estimated ink usage.

16. The method of claim 1, where the distance between multiple graphical images are constrained based on estimated ink usage.
